(19) United States
(12) Patent Application Publication
(10) Pub. No.: US 2003/0178791 A1
(43) Pub. Date: Sep. 25, 2003

(54) Seal film of vacuum test assembly

(76) Inventor: Chi-Chieh Huang, Taichung (TW)

Correspondence Address: Charles E. Baxley, Hart, Baxley, Daniels & Holton, Fifth Floor, 59 John Street, New York, NY, 10038, US

(21) Appl. No.: 10/104,531

(22) Filed: Mar. 25, 2002

(51) Int. Cl. F16J 3/00

(52) U.S. Cl. 277/628

(57) ABSTRACT

A vacuum test assembly includes a body (20) having a piston (22) movably received therein and a valve (30) is received in the body with a gauge (31) connected thereto. The valve has a passage (32) which defines an opening at an end of the valve. An annular groove (33) is defined in an outer periphery thereof. A seal film has a skirt portion having a clamp flange (41) which is engaged with the annular groove. Two apertures (42) are defined through the seal film.

### FIELD OF THE INVENTION

The present invention relates to a seal film of a vacuum test assembly and has a clamp flange to be engaged with the valve and an annular flange seals the opening of the valve.

### BACKGROUND OF THE INVENTION

A conventional vacuum test assembly is shown in FIGS. 4 and 5 and includes a casing 10 with a piston 17 movably received therein and a valve 11 is received in the casing 10. A gauge 18 is connected to the valve 11 and a passage 13 is defined in the valve 11. A recess 14 is defined in an end of the valve 11. A seal film 15 is put at the end of the valve 11 and seal the opening of the passage 13 at the end of the valve 11. A spring clamp 16 is engaged with the recess 14 to position the seal film 15. The piston 17 is moved toward the valve 11 to press the seal film 15 onto the opening and the seal film 15 is pulled away from the opening of the passage 13 when the piston 17 is moved away from the valve 11. It is experienced that the seal film 15 is easily to be deformed or broken and cannot seal the opening of the passage 13 so that it is replaced frequently. A special tool is required to remove the spring clamp 16 and this takes time.

### SUMMARY OF THE INVENTION

In accordance with one aspect of the present invention, there is provided a vacuum test assembly which comprises a body with a piston and a valve respectively received therein and a gauge is connected to the valve which has a passage defined therethrough so as to define an opening at an end of the valve. An annular groove is defined in an outer periphery thereof. A seal film has a skirt portion and a clamp flange extends inward from an edge of the skirt portion so as to engage with the annular groove. Two apertures are defined through the seal film.

The primary object of the present invention is to provide a seal film which is clamped onto the valve and is flexible so that is easily to be replaced without a need of tools.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the seal film, the valve and the gauge of the vacuum test assembly of the present invention;

FIG. 2 is a cross sectional view to show the seal film is securely pressed on the end of the valve;

FIG. 3 is a cross sectional view to show the seal film is sucked away from the end of the valve;

FIG. 4 is an exploded view to show the conventional seal film, the spring clamp, the valve and the gauge, and

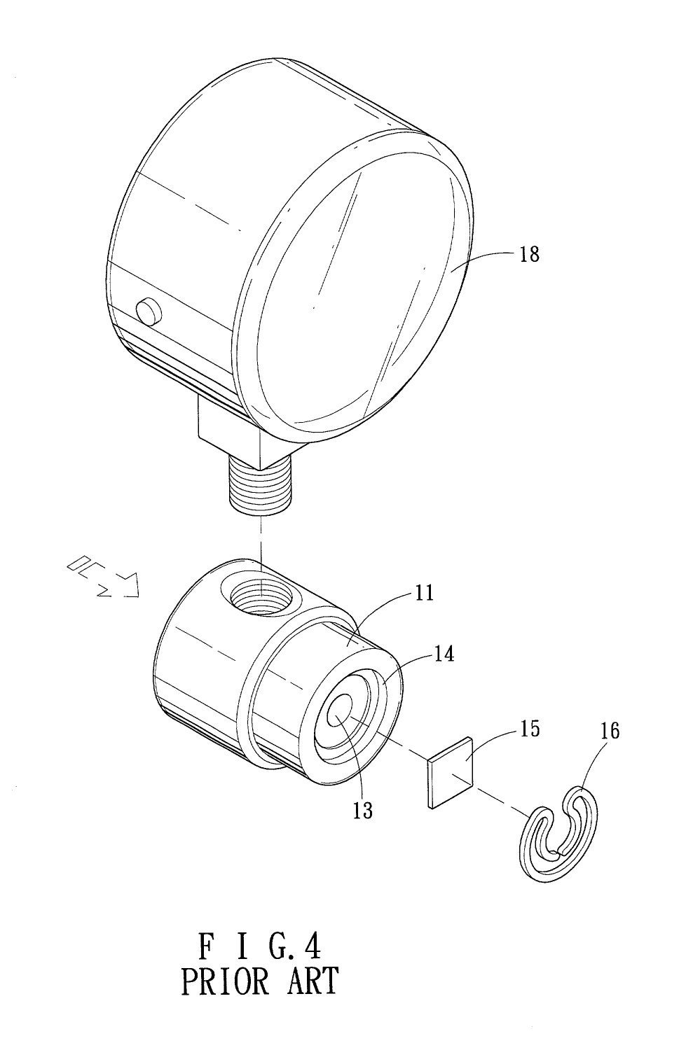

FIG. 5 is a cross sectional view to show the conventional seal film securely pressed on the end of the valve.

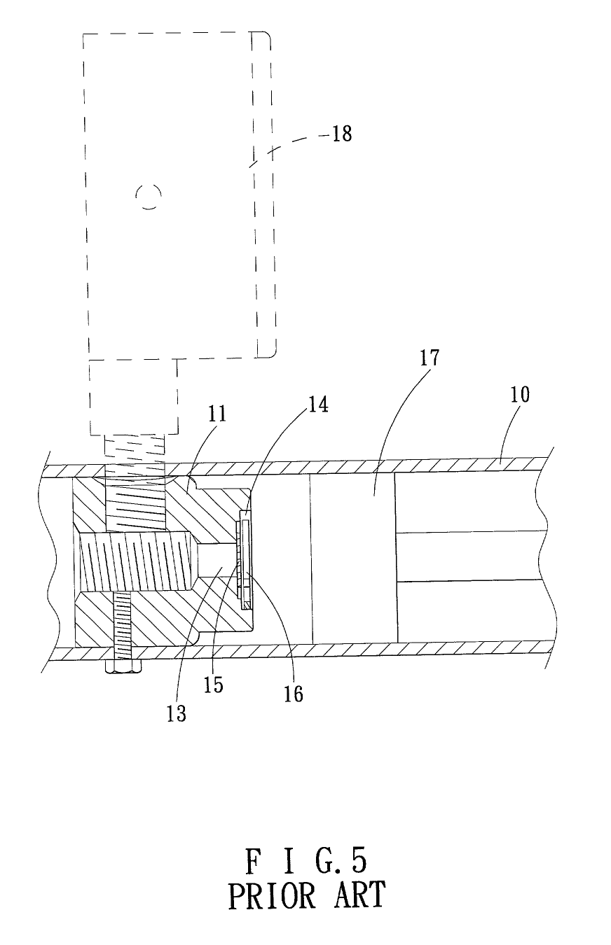

### DETAILED DESCRIPTION OF THE PREFERRED EMBODIMENT

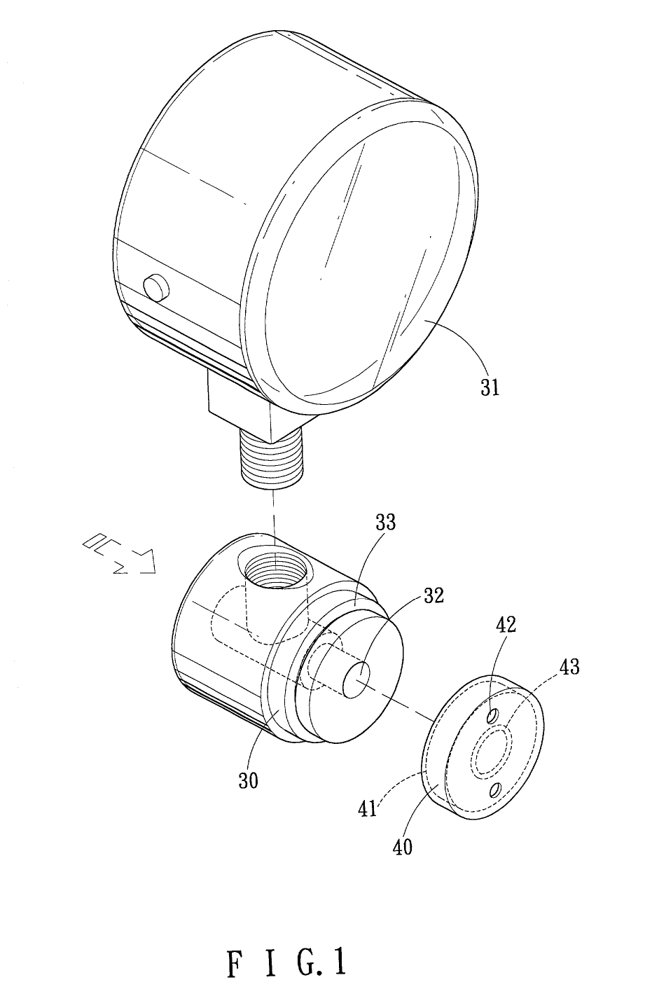

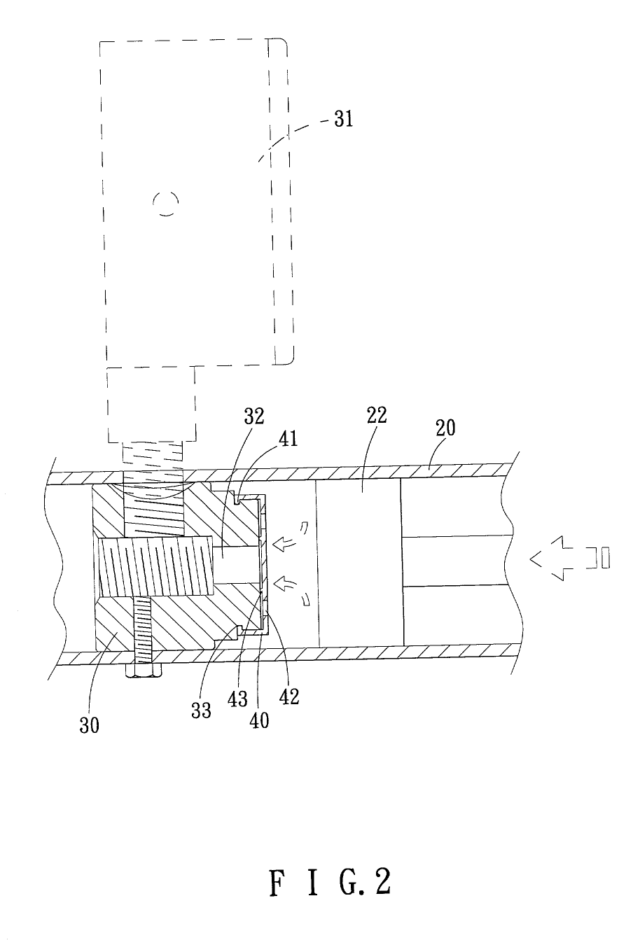

Referring to FIGS. 1 and 2, the vacuum test assembly of the present invention comprises a body 20 and a piston 22 is movably received therein. A valve 30 is received in the body 20 and a passage 32 is defined therethrough so as to define an opening at an end of the valve 30. A bolt is engaged with the passage 32 from the other end of the valve 30 and a gauge 31 is threadedly connected to the valve 30 via the wall of the body 20. An annular groove 33 is defined in an outer periphery thereof.

A seal film 40 made of flexible material has a skirt portion and a clamp flange 41 extends inward from an edge of the skirt portion. The clamp flange 41 is engaged with the annular groove 33 so that the seal film 40 is connected to the end of the valve 30. Two apertures 42 are defined through the seal film 40 and are no located in alignment with the passage 32. An annular flange 43 extends from an inside of the seal film 40 and is located to enclose the opening at an end of the valve (32).

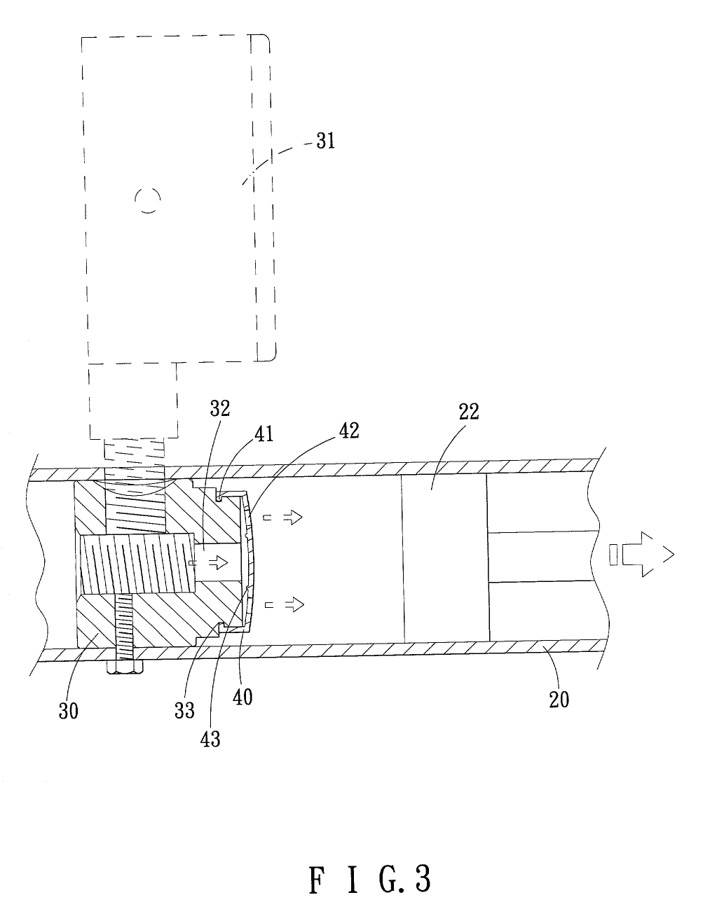

When the piston 22 is moved toward the valve 30 as shown in FIG. 2, the seal film 40 is securely pressed on the end of the valve 30 and the annular flange 43 seal the opening of the valve 30. As shown in FIG. 3, when the seal film piston 22 is moved away from the valve 30, the seal film 40 is sucked away from the end of the valve 30. The annular flange 43 is separated from the end of the valve 30 and air may released from the two apertures 42.

The seal film 40 is connected to the end of the valve 30 by itself without using a spring clamp and the seal film 40 is easily to be replaced.

While we have shown and described the embodiment in accordance with the present invention, it should be clear to those skilled in the art that further embodiments may be made without departing from the scope of the present invention.

What is claimed is:

1. A vacuum test assembly comprising:
a body having a piston movably received therein and a valve received in the body, a gauge connected to the valve which has a passage defined therethrough so as to define an opening at an end of the valve, an annular groove defined in an outer periphery thereof, and
a seal film having a skirt portion and a clamp flange extending inward from an edge of the skirt portion, two apertures defined through the seal film, the clamp flange engaged with the annular groove.

2. The assembly as claimed in claim 1 further comprising an annular flange extending from an inside of the seal film and the annular flange located to enclose the opening at an end of the valve.
